(19) United States
(12) Patent Application Publication
(10) Pub. No.: US 2017/0108892 A1
(43) Pub. Date: Apr. 20, 2017

(54) WEARABLE COMPUTING SYSTEM

(71) Applicant: ATOMIC VR INC, Bothell, WA (US)

(72) Inventor: Michael Lenzi, Bothell, WA (US)

(21) Appl. No.: 15/294,202

(22) Filed: Oct. 14, 2016

Related U.S. Application Data
(60) Provisional application No. 62/241,153, filed on Oct. 14, 2015.
(60) Provisional application No. 62/242,902, filed on Oct. 16, 2015.

(51) Int. Cl. G06F 1/16; A41D 1/00; A41D 1/04; G06F 1/26

(52) U.S. Cl. CPC G06F 1/163; G06F 1/263; A41D 1/002; A41D 1/04

(57) ABSTRACT

A wearable computer system which may be used in various applications including virtual reality, augmented reality and mixed reality applications. The system may be worn by a user while using such systems and applications. Power may be supplied by a battery which powers a computer, a graphics card, a head mounted display and other peripherals. The system may include a counterbalanced configuration of the power supply and computing components through strategic placement to achieve optimal weight balance between a front portion and a rear portion of the wearable computing system, and may include a frame that allows for protection and proper ventilation for standing, seated or lying (front or back) user positions. The system may also include one or more tracking markers and/or tracking devices built or placed on the system for tracking the spatial position and orientation of the user using optical, RF, or ultrasonic tracking technologies, for example.

### BACKGROUND

Technical Field

The present disclosure generally relates to the field of wearable computing. More specifically, the implementations of the present disclosure provide a wearable computing system for use in immersive technology applications, including, but not limited to, virtual reality, augmented reality, mixed reality and so forth.

Description of the Related Art

There are several known devices for wearable immersive computing. Most of these are self-contained computers connecting to various types of head mounted displays, in various form factors such as backpacks or bags.

In recent years, virtual reality and other immersive technology devices have become more common as a way to visualize various forms of media in three dimensions.

Issues with limited signal bandwidth and lack of products capable of transmitting high resolution and high frame rate video signals has spawned interest in wearable computing in order to render the graphical images in real time locally for the user.

### BRIEF SUMMARY

One or more implementations of the present disclosure provide a wearable computing system solution for immersive computing applications such as virtual reality, augmented reality and mixed reality, providing an untethered solution, enabling a “free to roam” experience. The wearable computing system may be configured to be worn by the user. Power may be provided by a battery solution or plug from an external power supply.

In at least some implementations, a wearable computing system is provided which includes, but is not limited to, a vest, backpack, shoulder bag, or harness that houses a computer, power supply, external graphics processor and battery, for example. The wearable computing system may also contain one or more haptic devices, such as small vibration motors, and/or various tracking systems for determining the user's body position in space. Examples of tracking technologies for determining the user's position include, but not limited to, optical, RF, accelerometer, and ultrasonic based methods.

The vest form factor may be best suited for high mobility types of activities as in at least some implementations the vest features a counterbalanced configuration of the battery, computer, voltage regulator(s) and graphics processor(s). In at least some implementations, the vest is sized and dimensioned to house the battery and optionally the voltage regulator(s) in the front of the vest to achieve a closely balanced state between the front and rear sections, with the computer, graphics card(s) and other components housed in the rear of the vest or any other possible combination to achieve optimal counter balancing within a maximum offset (e.g., 1-2 pounds) between the front and rear sections. Having the battery in the front of the vest also allows for convenient hot swapping of the battery. The rear portion of the vest may be designed for proper ventilation, heat dissipation, and structural support. Such structural support to protect the components from impact is particularly advantageous for applications in which the user is lying on his or her back or seated in a chair, for example. The bag configuration may be best suited for a more casual application that does not require high activity from the user and can also be worn while the user is in a seated position.

A wearable computing system may be summarized as including: a vest having a front portion and a rear portion, the front portion positionable adjacent a front side of a user's body when worn by the user, the rear portion positionable adjacent a back side of the user's body when worn by the user; and at least one processor; at least one power supply operatively coupled to the at least one processor to supply power thereto; and at least one battery electrically coupled to the at least one power supply, wherein a first subset of the at least one processor, the at least one power supply and the at least one battery is supported on the front portion, the front portion including the first subset having a combined first weight, and a second subset of the at least one processor, the at least one power supply and the at least one battery is supported on the rear portion, the rear portion including the second subset having a combined second weight, and the difference between the first weight and the second weight is less than or equal to a counterbalance threshold.

The counterbalance threshold may be equal to 2 pounds. The counterbalance threshold may be equal to 0.5 pounds. The first weight may be within 15% of the second weight. The at least one processor may include at least one general processor and at least one graphics processing unit. The at least one battery may be supported on the front portion. The at least one processor and the at least one power supply may be supported on the rear portion. The at least one power supply may include at least two power supplies. The at least one battery may include at least two batteries. The rear portion may include a rear base plate spaced apart from a rear top plate, and at least one of the at least one processor, the at least one power supply and the at least one battery may be positioned in the space between the rear base plate and the rear top plate. The rear portion may include a rear top plate which includes a plurality of ventilation openings. The at least one battery may be housed in a battery housing. The vest may include at least one coupling feature which selectively couples the front portion of the vest to the rear portion of the vest. The rear portion may include a rear base plate spaced apart from a rear top plate, and at least one of the at least one processor, the at least one power supply and the at least one battery may be positioned in the space between the rear base plate and the rear top plate, the wearable computing system further comprising: a thermal shield coupled to the rear portion of the vest, the thermal shield positionable between the rear base plate and the user's body when the wearable computing system is worn by the user. The rear portion may include a rear base plate spaced apart from a rear top plate, and at least one of the at least one processor, the at least one power supply and the at least one battery may be positioned in the space between the rear base plate and the rear top plate, the wearable computing system further comprising: at least one standoff which creates an air gap between the rear base plate and the vest. The at least one battery may include a primary battery and a secondary battery, the secondary battery operative to provide power to the at least one processor for a period of time when the primary battery is unavailable to provide power.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a top plan view of a wearable computing system, according to one illustrated implementation.

FIG. 2 is a perspective view of the wearable computing system, showing a rear/baseplate and the housed components thereof, according to one illustrated implementation.

FIG. 3 is a left side perspective view of the wearable computing system when worn by a user with a head mounted display attached to the wearable computing system, according to one illustrated implementation.

FIG. 4 is a right side perspective view of the wearable computing system when worn by a user, according to one illustrated implementation.

FIG. 5 is a rear perspective view of the wearable computing system showing a rear cover thereof, according to one illustrated implementation.

FIG. 6 is a perspective view of the wearable computing system, showing the rear cover removed and the configuration of rear components of the wearable computing system, according to one illustrated implementation.

FIG. 7 is a perspective view of the rear of the wearable computing system, showing a rear baseplate layer, thermal shield and a graphics processor of the wearable computing system, according to one illustrated implementation.

FIG. 8 is a front perspective view of the wearable computing system, showing a battery housing thereof, according to one illustrated implementation.

FIG. 9 is a block diagram of the various components of the wearable computing system, showing how the components are connected together, according to one illustrated implementation.

FIG. 10 is a perspective view of the wearable computing system when docked on a humanoid half mannequin, according to one illustrated implementation.

FIG. 11 is a schematic view of the front and rear sections of the wearable computing system, detailing a fabric mesh layer in relation to the rear plate and an umbilical cord connection, according to one illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

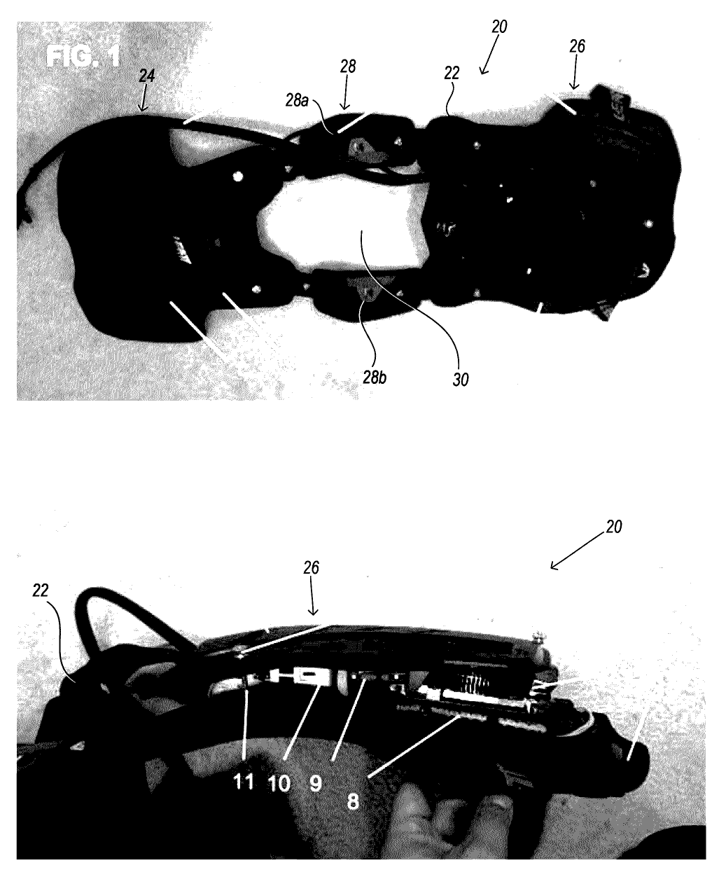

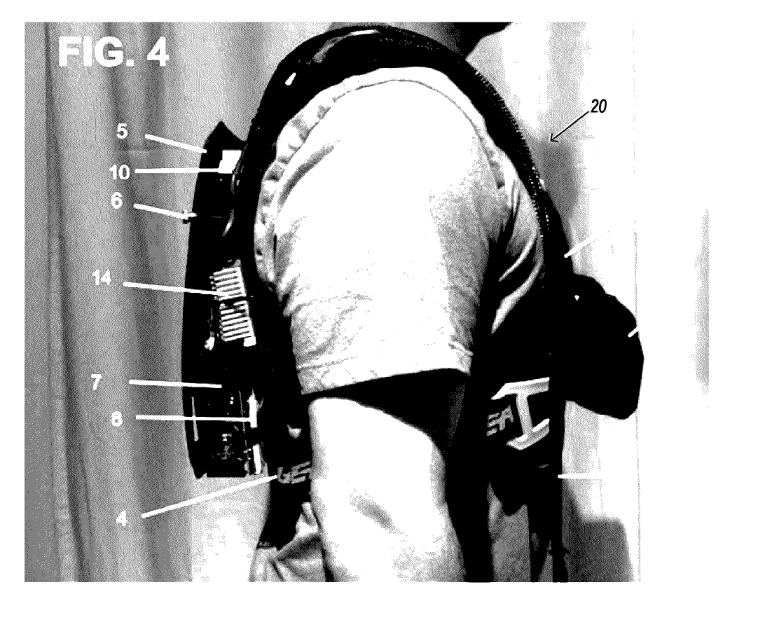

FIG. 1 shows a perspective view of a wearable computing system 20 in an assembled state. The wearable computing system 20 includes a wearable vest 22 which supports a plurality of components, as discussed further below. The vest 22 includes a front portion 24 coupled to a rear portion 26 by a shoulder or middle portion 28. The shoulder portion 28 includes two spaced apart sections 28a and 28b which are each coupled to the front portion 24 and the rear portion 26 of the vest 22. The spaced apart sections 28a and 28b form an opening 30 through which a user's head may be positioned such that the spaced apart sections rest on the user's shoulders during use. The vest 22 may also include coupling features 32 (FIG. 3), such as one or more straps and/or buckles, on the lateral sides of the front portion 24 and/or the rear portion 26 to help secure the vest to the user during use.

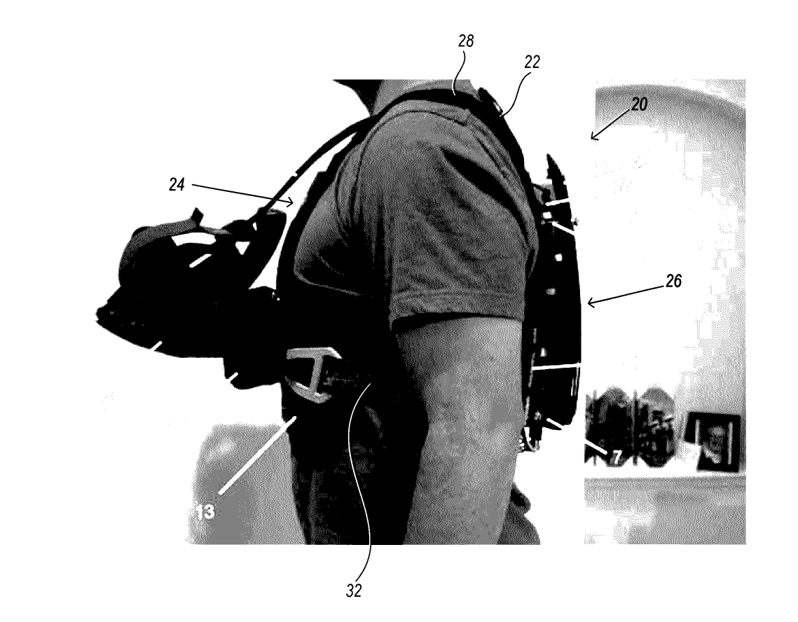

A battery housing and battery 1 are shown attached to a front plate 13 which is disposed on the front portion 24 of the vest 22. The battery 1 is connected to a main power wire 3. The main power wire 3 is connected to both a DC voltage regulator 9 (FIG. 2), such as a 12 V regulator, and a DC adjustable voltage regulator 14 (FIG. 4) housed between a rear base plate 4 and a rear top plate 5 on the rear portion 26 of the vest 22. A head mounted display wire loom 2 is connected to a computer 10 which is housed between the rear base plate 4 and rear top plate 5 on the rear portion 26 of the vest 22. When the battery 1 is not in use, in at least some implementations an external power supply may be plugged into the vest 22 to power the components and to also charge the battery 1 while the wearable computing system 20 is being worn, docked or unused.

In at least some implementations, position tracking devices and/or markers may be built into areas of the rigid front plate 13 (FIG. 1) and rear plates 4 and 5 to allow for body tracking. Such position tracking devices or markers may use optical, RF, ultrasonic or other position tracking technologies. Additionally, in at least some implementations, haptic devices may be strategically placed on the front plate 13 and/or rear plates 4 and 5 to create a higher resolution haptic feedback system. The haptic feedback system may also be used to notify the user of the bounds of a tracking space, notify the user of potential collisions and/or provide general direction cues, for example. Additionally, larger haptic devices may be used to create higher feedback responses, emulating loud, low frequency effects, as one example.

FIG. 2 shows a perspective view of the rear portion 26 of the vest 22 form factor. The rear base plate 4 acts as the mounting surface for the computer 10, a DC adjustable voltage regulator 14, the DC 12V voltage regulator 9 and a graphics processor 7. The rear top plate 5 acts as a protective cover and ventilation feature for the housed components. This configuration allows for proper ventilation of the housed components even if rear top plate cover 5 is obstructed or covered, as there is still adequate ventilation to the sides, top and bottom of the structure. The rear top plate 5 may be attached to the rear base plate 4 by an attachment feature 6, connected by a plate support pillars 11, and acts as a support structure protecting the housed components between the rear base plate and rear top plate. In at least some implementations, the support structure may be made to withstand up to 300 pounds of weight of the user lying on his or her back while wearing the wearable computing system 20. The support structure may also include a suspension system able to absorb shock from impact and movement of the user.

FIG. 3 shows a perspective view of the wearable computing system 20 when worn by a user. The battery housing and battery 1 are disposed in the front portion 24 of the vest 22, and in at least some implementations act as a counterbalance to the computer 10, graphics processor 7, DC 12V voltage regulator 9, DC voltage regulator 14, which are housed in the rear portion 26 of the vest 22. In at least some implementations, the weight tolerance between the front portion 24 and the rear portion 26 of the vest 22 is within approximately 15% weight distribution ratio. A head mounted display 12 is also shown being held by the user. In at least some implementations, an attachment, such as a hook or magnet system, may be built into the front plate 13 to attach the head mounted display 12 to when the head mounted display is not in use.

FIG. 4 shows a right side perspective view of the wearable computing system 20 worn by a user, with no head mounted display 12 attached.

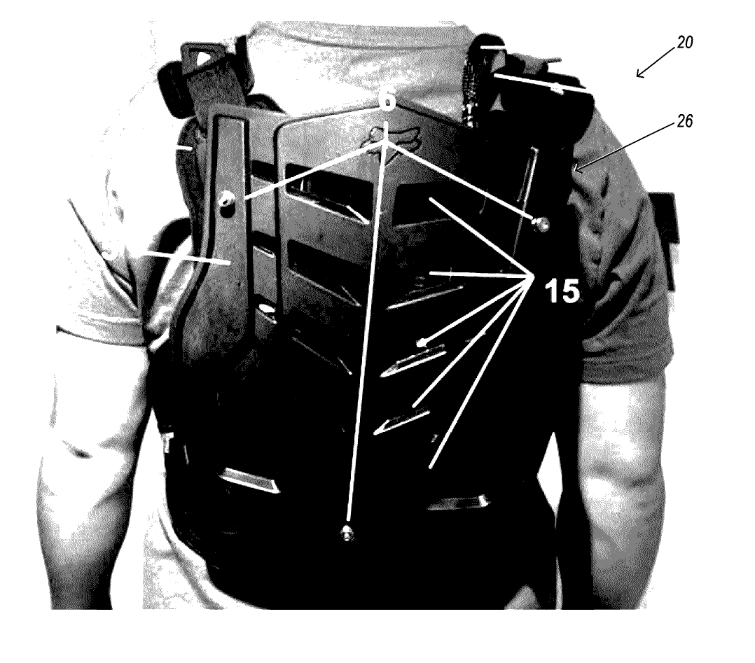

FIG. 5 shows a perspective view of the back of the wearable computing system when worn by a user. Ventilation features 15 (e.g., openings) on the rear plate 5, allows cooling systems of the computer 10, graphics processor 7, DC 12V voltage regulator 9, and DC adjustable voltage regulator to be air cooled. In at least some implementations, the cooling systems/heatsinks of these components are designed to take advantage of the large surface area under the rear top plate 5 to enable a low number of fans or even a fanless design.

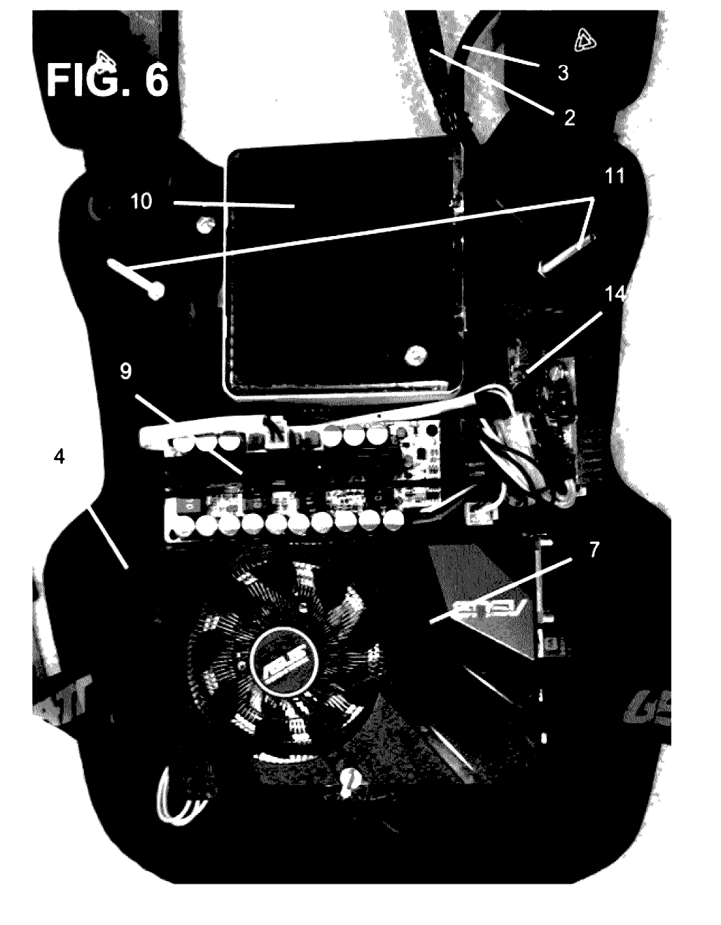

FIG. 6 shows a perspective view of the wearable computing system 20 with the rear top plate 5 removed to show the computer 10, DC 12V voltage regulator 9, DC adjustable voltage regulator 14, plate support features 11 and graphics processor 7. Any number of placement configurations of these components can be used to allow for the best weight distribution, ergonomics, and cooling scenarios.

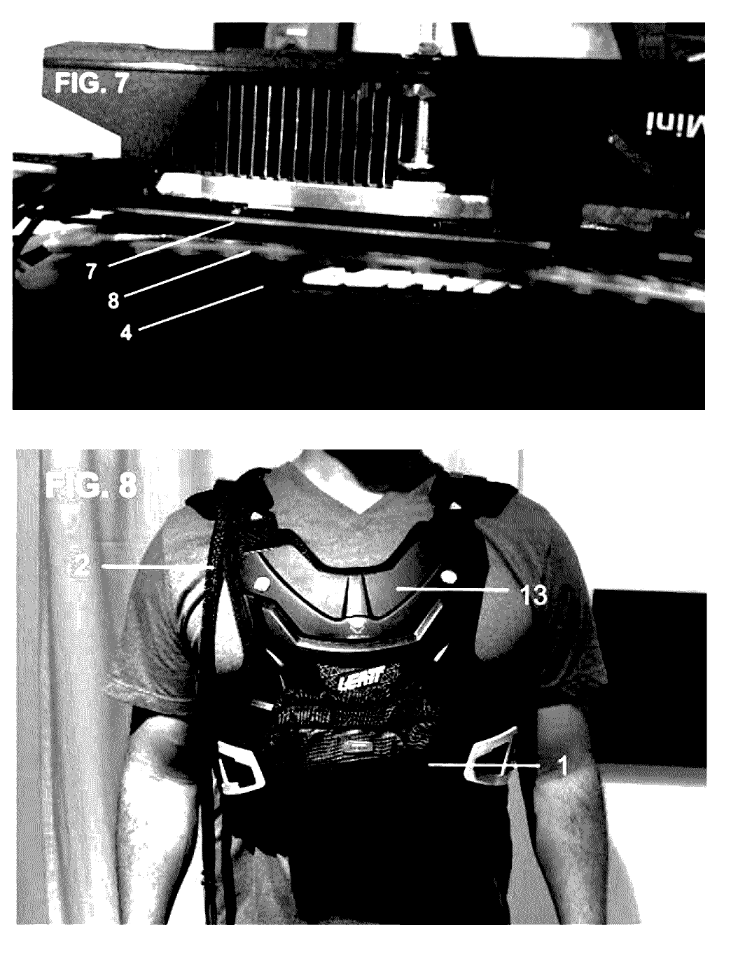

FIG. 7 shows a detailed profile view of the rear base plate 4, a thermal shield 8, and the graphics processor 7. In at least some implementations, all of the components' cooling systems may be designed to direct heat away from the user's body. Additionally, in at least some implementations, a thermal barrier, such as an aluminum sheet, ceramic, or silicon layer or any combination of these layers/materials, is placed between the user and any heat generating components or complete surface area of the components mounting structure. Additionally, maintaining a space (e.g., ½ to 2 inches) between a fabric layer/mesh and the component housing structure may also add a layer of thermal shielding and extra ventilation, while also increasing comfort by reducing contact of the user's body from the rigid component mounting structure.

FIG. 8 shows a perspective view of the front portion 24 of the wearable computing system 20. In at least some implementations, the front plate 13 houses a power switch and battery level gauge. The battery level gauge may emit a signal (e.g., audible alarm) when the battery is critically low, and may be coupled with a display method viewed in the head mounted display 12 to notify the user of the battery health and levels. In at least some implementations, the battery may be placed in the front portion 24 of the vest 22 to allow for hot swapping batteries by the user while the user is wearing the wearable computing system 20. A second, possibly smaller battery could also be placed in the front section 24 of the vest 22 to act as a power source while the hot swapping action is taking place so that there is no disruption in power to the components. A similar hot swapping battery feature may also be used in the backpack form factor, where the batteries could be housed on the front of backpack's straps for easy access.

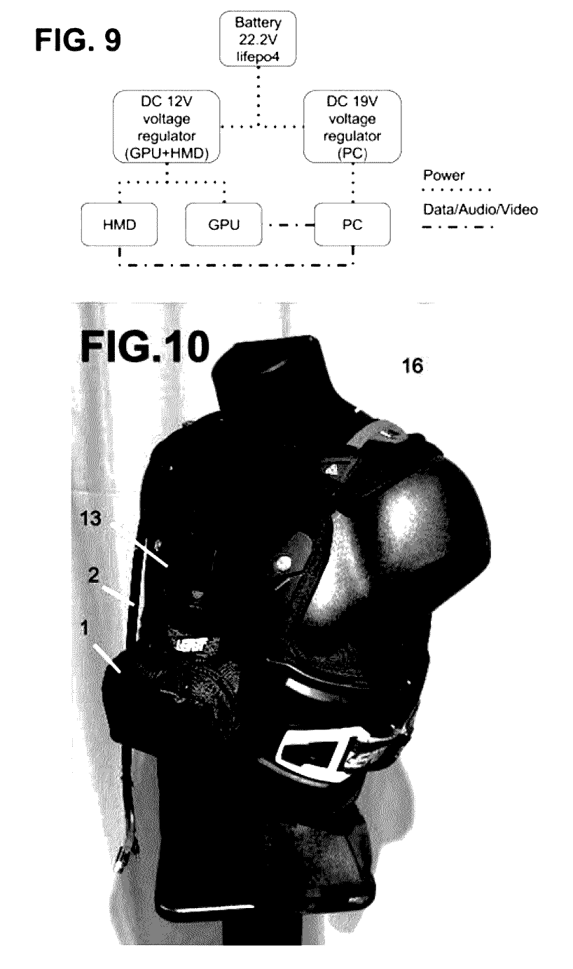

FIG. 9 shows a simple block diagram demonstrating the basic connectivity between the components of the wearable computing system 20. In particular, the diagram shows the connection between the computer 10, the graphics processor 7, the head mounted display 12, the DC 12 V voltage regulator 9, the DC adjustable voltage regulator 14, and the battery 1.

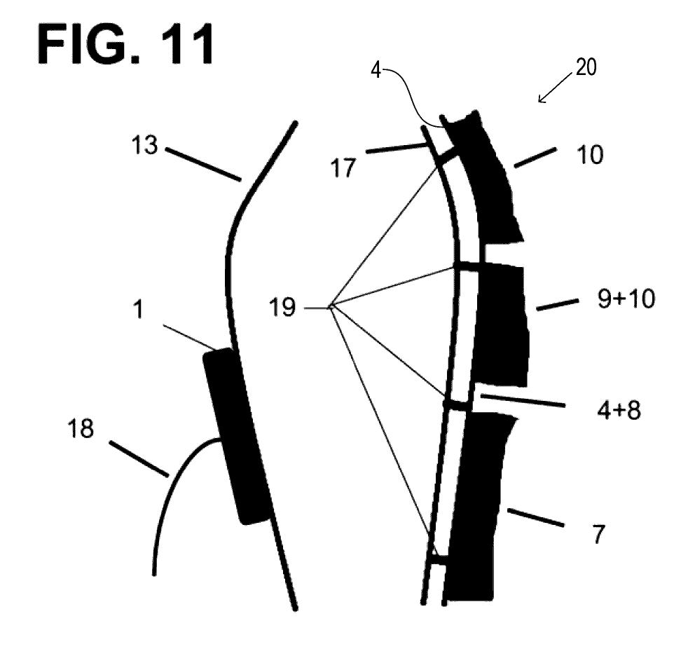

FIG. 10 shows an exemplary docking station 16 configuration for the vest 22 of the wearable computing system 20. A humanoid mannequin 16 may have an attachable umbilical cord 18 (FIG. 11) enabling power, audio, video and data connectivity to use the wearable computing system as a standard computer with an external mouse, keyboard and monitor, for instance. For a bag or backpack form factor, the same umbilical cord mechanism 18 could apply and the cord may be attached to a mechanism allowing for desktop, wall mount, floor stand, or chair mounted scenarios.

FIG. 11 shows a perspective view of the wearable computing system 20. In this example, a removable umbilical cord 18 is disposed on or adjacent the front portion 24 which allows for external power, audio, video and/or data connectivity. While the umbilical cord 18 is attached to the wearable computing system 20, the wearable computing system may be used as a standard computer while also charging the one or more batteries 1.

In the example shown in FIG. 11, a fabric mesh layer 17 connects to the rear base plate 4 via standoffs 19 which allow for a space (e.g., 1 inch) between the fabric mesh layer and the rear base plate, which enables better ventilation from the user's body and the housed components. Further thermal shielding may be provided using thermal materials such as aluminum, silicon, ceramic, etc., in any combination.

Although the preceding description contains significant detail, it should not be construed as limiting the scope of the present disclosure but rather as providing illustrations of the one or more implementations of the present disclosure. As an example, the configuration of the battery, computer, graphics processor and voltage regulators may be arranged in any combination to achieve the optimal counterbalanced state with a certain tolerance (e.g., 1 to 2 pounds) maximum offset between the front and rear sections of the implementations discussed herein. Further, the wearable computing systems of the present disclosure may include additional or fewer components than the particular implementations discussed above. Such variations do not materially alter the nature of the present disclosure.

The wearable computing system may be used for, for example, virtual reality, augmented reality, mixed reality applications. The wearable computing system may include a computer; a battery; a voltage regulator(s); a graphics processor(s); and a vest, bag, or backpack. The computer, battery, voltage regulator(s), graphics processor(s) may be mounted, housed, or built into a vest, bag, backpack or other wearable system. The computer, battery, voltage regulator(s), graphics processor(s) may be configured in the vest form factor with any configuration of components to achieve an optimal counterbalance state with a maximum offset (e.g., 0-2 pounds) between the front and rear sections of the wearable computing system.

The wearable computing system may contain customizable, detachable faceplates or covers for branding or personal customization in a vest form factor by a modular attachment point system. The wearable computing system may contain built-in position tracking devices/markers in a vest, bag, or backpack form factor to track body position of the user. These tracking devices/markers may be, but are not limited to, optical, RF, or ultrasonic tracking technologies.

The wearable computing system may be designed to dock to a humanoid mannequin, countertop, desktop, ceiling or wall mounted mechanism/umbilical/docking station for, but not limited to, vest, bag or backpack form factors.

The wearable computing system may be built into a layered frame/structure for thermal protection, comfort and ventilation of computer, power, graphics processor(s) that also enables the ability for a user to lay on their back or sit in a chair while maintaining structural integrity and functionality of enclosed, mounted or housed components of the wearable computing system, of reasonable average human weight (250-300 pounds force rating), and proper ventilation of all heat generating components with either poses.

The wearable computing system may contain attachable arm and leg straps with parts containing positional tracking devices and/or markers to track the pose and position of the user's arms and legs in relation to the rest of the user's body.

The wearable computing system may contain a removable battery to enable “hot-swapping” and also a second, possibly smaller battery to handle a duration of runtime (e.g., 2-5 minutes) of the powered components to allow a reasonable time to perform the battery swap.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. To the extent that they are not inconsistent with the specific teachings and definitions herein, all of the U.S. patents, U.S. patent application publications, U.S. patent applications, foreign patents, foreign patent applications and non-patent publications referred to in this specification, including U.S. Provisional Patent Application Ser. No. 62/241,153, filed Oct. 14, 2015, and U.S. Provisional Patent Application Ser. No. 62/242,902, filed Oct. 16, 2015, are incorporated herein by reference, in their entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A wearable computing system, comprising:
a vest having a front portion and a rear portion, the front portion positionable adjacent a front side of a user's body when worn by the user, the rear portion positionable adjacent a back side of the user's body when worn by the user; and
at least one processor;
at least one power supply operatively coupled to the at least one processor to supply power thereto; and
at least one battery electrically coupled to the at least one power supply,
wherein a first subset of the at least one processor, the at least one power supply and the at least one battery is supported on the front portion, the front portion including the first subset having a combined first weight, and a second subset of the at least one processor, the at least one power supply and the at least one battery is supported on the rear portion, the rear portion including the second subset having a combined second weight, and the difference between the first weight and the second weight is less than or equal to a counterbalance threshold.

2. The wearable computing system of claim 1 wherein the counterbalance threshold is equal to 2 pounds.

3. The wearable computing system of claim 1 wherein the counterbalance threshold is equal to 0.5 pounds.

4. The wearable computing system of claim 1 wherein the first weight is within 15% of the second weight.

5. The wearable computing system of claim 1 wherein the at least one processor comprises at least one general processor and at least one graphics processing unit.

6. The wearable computing system of claim 1 wherein the at least one battery is supported on the front portion.

7. The wearable computing system of claim 6 wherein the at least one processor and the at least one power supply are supported on the rear portion.

8. The wearable computing system of claim 1 wherein the at least one power supply comprises at least two power supplies.

9. The wearable computing system of claim 1 wherein the at least one battery comprises at least two batteries.

10. The wearable computing system of claim 1 wherein the rear portion includes a rear base plate spaced apart from a rear top plate, and at least one of the at least one processor, the at least one power supply and the at least one battery is positioned in the space between the rear base plate and the rear top plate.

11. The wearable computing system of claim 1 wherein the rear portion includes a rear top plate which includes a plurality of ventilation openings.

12. The wearable computing system of claim 1 wherein the at least one battery is housed in a battery housing.

13. The wearable computing system of claim 1 wherein the vest comprises at least one coupling feature which selectively couples the front portion of the vest to the rear portion of the vest.

14. The wearable computing system of claim 1 wherein the rear portion includes a rear base plate spaced apart from a rear top plate, and at least one of the at least one processor, the at least one power supply and the at least one battery is positioned in the space between the rear base plate and the rear top plate, the wearable computing system further comprising:
a thermal shield coupled to the rear portion of the vest, the thermal shield positionable between the rear base plate and the user's body when the wearable computing system is worn by the user.

15. The wearable computing system of claim 1 wherein the rear portion includes a rear base plate spaced apart from a rear top plate, and at least one of the at least one processor, the at least one power supply and the at least one battery is positioned in the space between the rear base plate and the rear top plate, the wearable computing system further comprising:
at least one standoff which creates an air gap between the rear base plate and the vest.

16. The wearable computing system of claim 1 wherein the at least one battery comprises a primary battery and a secondary battery, the secondary battery operative to provide power to the at least one processor for a period of time when the primary battery is unavailable to provide power.
